(19) United States
(12) Patent Application Publication
(10) Pub. No.: US 2003/0016143 A1
(43) Pub. Date: Jan. 23, 2003

(54) Intersection vehicle collision avoidance system

(76) Inventor: Ohanes Ghazarian, Henderson, NV (US)

Correspondence Address: OHANES GHAZARIAN, 308 GONDOLA WAY, HENDERSON, NV, 89074, US

(21) Appl. No.: 10/200,905

(22) Filed: Jul. 22, 2002

Related U.S. Application Data
(60) Provisional application No. 60/307,574, filed on Jul. 23, 2001.

(51) Int. Cl. G08G 1/00

(52) U.S. Cl. 340/901; 340/902; 340/905; 340/907

(57) ABSTRACT

The present invention discloses a system that alerts to the operator of a vehicle, when a particular vehicle operator is not in the course of slowing down to stop a vehicle traveling towards an intersection, in particularly when said vehicle moving direction intersection traffic light condition turns ember and or red. Or where an intersection requires all or particular direction travel vehicles to make a full stop before said vehicles cross said intersection, to avoid intersection vehicle collision. The system comprises of traffic light or stop sign RF transceivers units, and plurality of vehicles equipped with vehicle transceivers units to communicate with said intersection traffic signal transceiver units. And said vehicle transceiver unit is equipped with vehicle speed sensors comparator CPU and vehicle movement direction detecting sensor circuitry, using transponder reader, compass or GPS receiver to detect vehicle direction movement, and to detect signal light condition along with monitoring vehicle speed. If a vehicle operator after receiving said warning signals at a predetermined time does not maintain vehicle speed in compliances with said traffic signal light condition, the vehicle mount speed comparator CPU will alert the pedestrians, other vehicle operators located within said particular intersection with an audio-visual or vibrating alarm signals. And upon said vehicle passing said intersection wile said traffic direction signal condition indicating an stop condition, said vehicle speed comparator CPU transmits said violation signal to a monitoring station with information containing to the particular vehicle and it's operator. Said monitoring station is equipped with a computer database connected to an Internet or intranet.

### BACKGROUND OF INVENTION

Vehicles, such as passenger cars, trucks, buses generally have the need to cross or pass intersections under the control of traffic signals or signs.

Since the earliest times, the driver of motor vehicles depended on such signals, and the decision to make pass a motor vehicle an intersection was solely depended on traffic signals and vehicle driver, based on driver vision, alertness, awareness, judgment etc. This has not always proven to be successful, in the pass and presently vehicles involve in intersection accidents are among the highest compare to vehicle accidents reports on the roads and highways, due to driver confusion, impaired, inattention, or overly aggressive driver attitude, and speed.

There have been many systems proposed to address problems of ability to warn drivers of presence of emergency vehicle at an intersection, or ability of an emergency vehicle to control traffic light, or controlling traffic light by satellite. One such system is disclosed in U.S. Pat. No. 5,926,113 to Jones et al. Where at a traffic signal preemption system, including a vehicle mount GPS receiver, for transmitting its GPS measurements by radio to a computer interfaced receiver at the controlled intersection, to determine the optimum time to switch a traffic light controller, to permit safe passage of an emergency vehicle.

U.S. Pat. No. 6,133,854 to Yee et al. Teaches a local traffic controller interfaced with satellite subscriber unit, to provide centralized control of traffic signals. The communication path may be utilized for accessing information from traffic signal controller.

U.S. Pat. No. 6,326,903 to Gross et al. Discloses a system that allows operators of emergency vehicle to obtain graphic data regarding other emergency vehicle that may pose threats of collision. Automatic signal takes place between emergency vehicles within range of each other to transmit directional data regarding the direction of travel of each emergency vehicle.

Although the findings in Jones et al., Yee et al., and Gross et al. and others are useful, but none of the prior arts capable of warning vehicle operator(s), whom fail to slow down to stop the vehicle in operation at a direction traveled towards an intersection, when in particularly intersection traffic light turns amber or red, Or where intersections using stops signs, which is posted to enforce crossing vehicles derivers to fully stop the vehicle(s) before passing through the intersection. In addition none of prior art teachings indicates wherein, when a vehicle driver ignores said vehicle mount unit warning to slow down signal(s), and makes no attempt to slow down to stop a particular vehicle in operation. Said vehicle mount unit automatically transmits warning signals to other vehicle drivers, to pedestrians, and or to a monitoring station equipped with a computer, to report such vehicle and it's driver information whom were in traffic violation, and in addition the present art teaching it be capable of automatically slowing down the vehicle in operation and or stopping the vehicle before vehicle crosses the intersection.

It is accordingly the primary objective of the present invention to avoid intersection vehicle collision by use of Electronic vehicle intersection collision avoidance system, which will alert to the vehicle operator(s) whom fails to slow the vehicle in operation from it's location position at a set distances from said intersection, for making a full stop at traffic signal(s), in particularly when the presence of traffic signal indicating “Stop” sign or “Red Light”. As such it is an objective of the Electronic intersection vehicle collision avoidance system of the present invention that it be capable of producing audio and or visual or vibrating warning signals to particular vehicle driver traveling a particular direction towards an intersection to slow down said vehicles for a full stop when a stop sign is posted or when traffic light turn red.

It is a related objective of the Electronic Intersection Vehicle collision avoidance system of the present invention capable of producing warning signals to certain vehicle operator(s) whom fail to slow down to stop the vehicle in operation, traveling in a particular lane of traffic towards an intersection, equipped with traffic signal(s) in particularly where there is a stop sign or when the traffic signal light turns “Amber or Red”.

It is still another objective of the Electronic Intersection Vehicle Collision Avoidance system of the present invention capable of warning other vehicle operators or pedestrians located near said intersection, only when a vehicle driver ignores said “Slow down” warning signal(s) generated by said vehicle speed comparator CPU.

It is the further objective of the Electronic Intersection vehicle collision Avoidance System to able to communicate with a monitoring station computer by a signal(s), containing information relating to a particular intersection location, vehicle, and it's operator whom ignored said vehicle unit generated warring signal and pass through an intersection posted stop sign(s) or red traffic signal light(s) without stopping.

It is still further objective of the Electronic Intersection Vehicle collision Avoidance system of the present invention is capable of notifying monitoring station computer (internet or intranet server) the whereabouts location of said intersection traffic signal violating vehicle(s), and indicating said vehicle ID information, driver ID information, and speed to help law enforcement to locate said vehicle(s), which made an illegal pass at an intersection, by the use of additional vehicle mount GPS unit and use of Patrol vehicle Lap top or Officer PDA unit.

It is further objective of the Electronic Intersection Vehicle collision avoidance system of the present invention that it be capable of determining when a vehicle driver ignores said slow down to stop warning signals produced by said vehicle unit, which upon detection of such event automatically slows down the vehicle by controlling said vehicle brakes.

The Electronic Intersection vehicle Collision Avoidance System of the present invention must be durable and long lasting nature and it should require little or no maintenance to be provided by the user throughout its operating lifetime. In order to enhance the market appeal of the present invention, its components should also be of relatively inexpensive construction to thereby afford it the broadest possible market. Finally, it is also an objective that all of the aforesaid advantage and objectives of the present invention be achieved without incurring any substantial relative disadvantage.

### SUMMARY OF INVENTION

Intersection vehicle accidents creates human life lose, and high property damage. Intersection Traffic lights most of the time helps to guide proper traffic flow. Intersections with good visibility helps lower the amount of intersection vehicle accident. Good and Alert driver avoid most intersection accident by driving in compliance with traffic signals and driving within speed limit.

However sometime drivers minds are distracted by deep thoughts or busy talking to passenger or even try to race the intersection traffic lights, which is one of the main causes of most intersection accidents.

It is according to the present invention, which is designed to avoid such unnecessary accidents, by use of Electronic Intersection Vehicle Collision Avoidance System. The system comprises of Vehicle equipped with a RF receiver or a transceiver, and a transponder read device(s) connected to vehicle mount speed compare-tore CPU with an audible, visual and or vibrating alarm warning devise.

According to the present invention, Street intersections using traffic lights or stop signs, are equipped with RF transmitters or transceivers with unique codes on each street side of the intersection traffic light, for identifying a particular traffic direction across each street intersection. 1^{st} row of transponder tags with a unique code are installed into each one of said traffic direction lane asphalt, or cement near intersection traffic signal lights(s)or stop sign(s) for identifying a particular traffic direction. A 2^{nd} row of transponder tags with a unique code installed into each one of said traffic direction lane approx. 20 feet apart from the 1^{st}. row of transponders for identifying a set distance from the 1^{st} row of transponders. A ^{3rd} row of transponder tags with a unique code is installed into each one of the traffic direction lane 20 feet apart from the 2^{nd} row of transponders. A ^{4th} row of transponder tags, with a unique code is installed on each one of the traffic lane 20 feet apart from the 3^{rd} row of transponders. And a 5^{th} row of transponder tags with a unique code are installed in each one of the traffic lane 20 feet apart from the 4rt row of transponders. Each one of in-between transponder row space is designed for creating a set vehicle speed zone where there is the presence of an intersection traffic signal.

When particular street intersection traffic lights turn amber or red; the traffic signal transmitter, transmits a unique RF coded signal. If a vehicle approaching towards the particular traffic direction light at a set distance the vehicle speed compare-tore receiver CPU unit receives the unique coded RF traffic signal, simultaneously the vehicle transponder reader unit reads the vehicle location street mount transponder tag(s), if street transponder location tag code corresponds with the particular traffic direction signal transmitter code, as vehicle approaches to the direction of AMBER or RED traffic light, the vehicle mount speed comparator CPU pending on vehicle location reads street transponder code, and the processor compares the vehicle speed by use of vehicle speedometer, or by use of an accelerometer which monitors vehicle speed, or compares the read laps time between the 5^{th}, 4^{th} and 3^{rd} to 2^{nd} to 1^{st} vertical raw of transponders to determine vehicle speed. If vehicle speed comparator reading indicates vehicle speed slowing down at a particular vehicle location distance from said intersection signal, the system operates in normal mode. If vehicle speed is not in compliance within said set distance location from traffic signal(s) (not in the course of slowing down), the vehicle mount compare-tore CPU unit will generates an audio visual or vibrating alarm signal, to alert the vehicle operator to slow down the vehicle, to avoid an intersection collision. At a predetermine time, if the driver does not comply, the vehicle lights will flash and horn will honk, to alert other vehicle drivers and pedestrians for avoiding a collision. Additionally the vehicle compare-tore CPU transceiver will transmit an RF emergency signal to alert other vehicles drivers, where other vehicles are equipped with speed comparator CPU, the CPU upon receipt of the warning signal, indicates with audio and or visual or vibrating signal the presence of a vehicle(s) who's driver is not being in compliance, located within the intersection.

According to the present invention stop signs used at intersections are equipped with similar transmitters with a unique code, when a vehicle equipped with a speed comparator receiver CPU approaching a particular intersection, the vehicle compare-tore CPU upon receipt of said RF signal will monitor said vehicle speed. If vehicle is in the course of slowing down and makes a full stop, the vehicle compare-tore CPU will not initiate warning alarm signal. If vehicle comparator CPU at set distance from the stop sign does not detect vehicle speed slow down. The vehicle compare-tore CPU will generate warning alarm signal(s) to the driver of the vehicle to slow down to stop the vehicle in operation.

Additionally the vehicle mount compare tore CPU is capable of reading operator RFID tag, smart card, key fob etc. to start the vehicle engine, and for the purpose of identifying the driver ID, and the comparator CPU using an RF transmitter with a unique code. And a traffic light mount RF transceiver is utilized to receive the transmitted signals. In this case if a driver does not stop at red traffic light, the vehicle speed compare-tore CPU transmits a signal containing information to particular vehicle, the driver along with violation event code. The transmitted signal will then be picked up by the particular intersection transceiver unit, which will relay the information along with traffic signal location information to a monitoring station, the monitoring station equipped with a PC, which logs the event information with date and time, and produce electronic ticketing.

In the preferred embodiment of the invention, the vehicle speed compare-tore CPU, instead use of vehicle speedometer, accelerometer or pending on street transponder read laps time to determine vehicle speed, a GPS (DGPS) unit is utilized, by connecting into vehicle speed cooperator CPU to monitor vehicle traveled direction and vehicle speed slowdown status, in particularly when particular intersection traffic lights turns amber or red.

In a practical and an economical, preferred embodiment of the present invention, the use of street intersection mount transponder tags may not be necessary at all. For indicating a vehicle travel direction, a vehicle mount compass could be utilized to determine vehicle moving direction, for the vehicle speed comparator CPU to be able match the vehicle moving direction code with particular direction intersection traffic signal code.

Or by use of GPS (DGPS) system in the vehicles, which determines vehicle location, speed, and traveling direction course by use of GPS longitude latitude in reference to a particular street intersection transmitter location. When a vehicle mount Intersection collision Avoidance unit receives a particular street intersection RF signal (traffic signal turns amber or red) the vehicle speed compare-tore CPU will compare the received GPS vehicle direction movement signal along with vehicle speed and vehicle traveled direction intersection traffic Control received RF signal. If vehicle speed is in the course of slowing down and or is into full stop at an intersection, the system operates normal. If vehicle speed is not slowing down as at set distance from the intersection signal, then the vehicle CPU generates an audiovisual alarm signal to alert the driver to slow down and stop the vehicle. If driver does not comply and pass the red traffic light, an optional vehicle mount GPS modem (GSM, Pager, satellite etc.) unit signals a monitoring station server, which receives the particular motor vehicle violation information at a particular street intersection location (vehicle longitude/latitude and speed). and logs said information in its database. The monitoring station (Law enforcement station) is capable of electronically issuing citations to particular vehicles or to its drivers. (Vehicles equipped with electronic driver authentication devise). Additionally Patrol vehicles may be equipped with on board computers (or palm PC) connected to the monitoring server, which helps patrol officer to pursuit the vehicle and give the driver a citation.

In another teaching of the art, the traffic signal location RF transmitted signal may not be necessary at all, the present art traffic Intersection RF transmitters could be replaced by use of satellite generated signals.

Better yet, the present invention vehicle GPS based receiver CPU in it's data base capable of storing city maps with intersection location information where stop signs are located, which in this teaching does not need to be equipped with RF transmitters (for the purpose of particular traffic intersection location identification). Or information regarding to streets or highway speed limits could be stored in the database. If and when a vehicle approaches any of said location intersection, the vehicle mount speed comparator CPU will compare said received GPS based direction travel and vehicle speed. If vehicle approaching a particular intersection and the vehicle GPS unit indicates vehicle speed slow down or indicates vehicle full stop, the system operates normally. If vehicle comparator CPU receive GPS signal does not indicate slow down in vehicle speed at a set distance from the particular intersection, then vehicle compare-tore CPU unit will transmit a warning alarm signal to the driver, if driver does not comply the vehicle speed comparator CPU will initiate warning alarm, to warn other vehicle(s) and pedestrians located within the intersection, street or highway. And if the driver pass the intersection without stopping the vehicle at the intersection. Or if the driver ignores the speed limit and drives faster, the vehicle GPS modem will transmit the vehicle and driver information along with vehicle location information to a monitoring station. And present invention method is capable of electronically maintaining vehicle speed under a particular location speed limit, by not letting the driver to accelerate the vehicle speed faster then a particular location speed limit transponder read code or by using vehicle GPS mapping street or highway speed limit code.

The present inventions vehicle comparator unit additionally could be connected to vehicle brake system (such as ABS). In an event the driver does not comply by the warning signals, then the vehicle mount speed comparator collision avoidance unit implements the vehicle brake system, to slows down the vehicle or bring the vehicle down to full stop, to avoid intersection collision.

### BRIEF DESCRIPTION OF THE DRAWING

This and other advantages of the present invention are best understood with reference to the drawings, in which;

FIG. 1 is a drawing with view of an Intersection having four traffic signal lights each one of said traffic light is equipped with RF transmitters. As shown certain Intersection traffic lane containing plurality of asphalt mount transponders, and plurality of vehicles equipped with electronic collision avoidance system.

FIG. 2 is a drawing with view of an intersection having four traffic lights each one of said traffic lights is equipped with RF transmitters. And as illustrated in the drawing, plurality of vehicles equipped with electronic collision avoidance system. And in addition showing GPS system integration.

FIG. 3 is a drawing with view of an intersection having four traffic stop signs, one equipped with a RF transceiver unit and a traffic speed sign. As illustrated in the drawing, plurality of vehicles equipped with Electronic vehicle collision avoidance system. And in addition showing GPS system interrogation.

FIG. 4 Is a Drawing of functional block diagram of the Electronic Vehicle Intersection Collision Avoidance System.

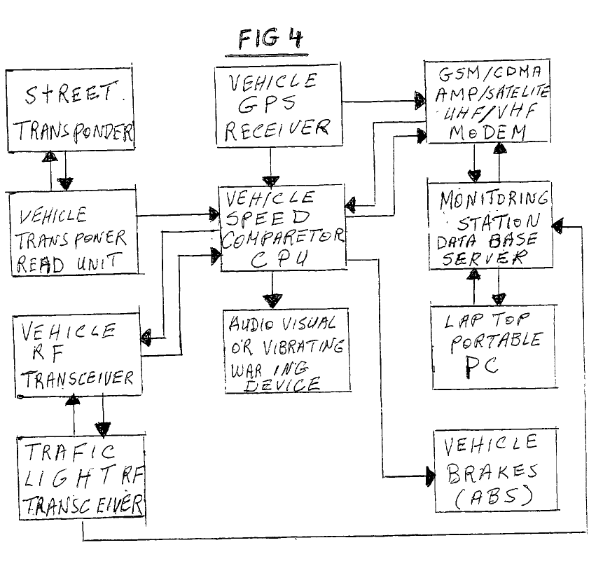

### DETAILED DESCRIPTION OF THE INVENTION

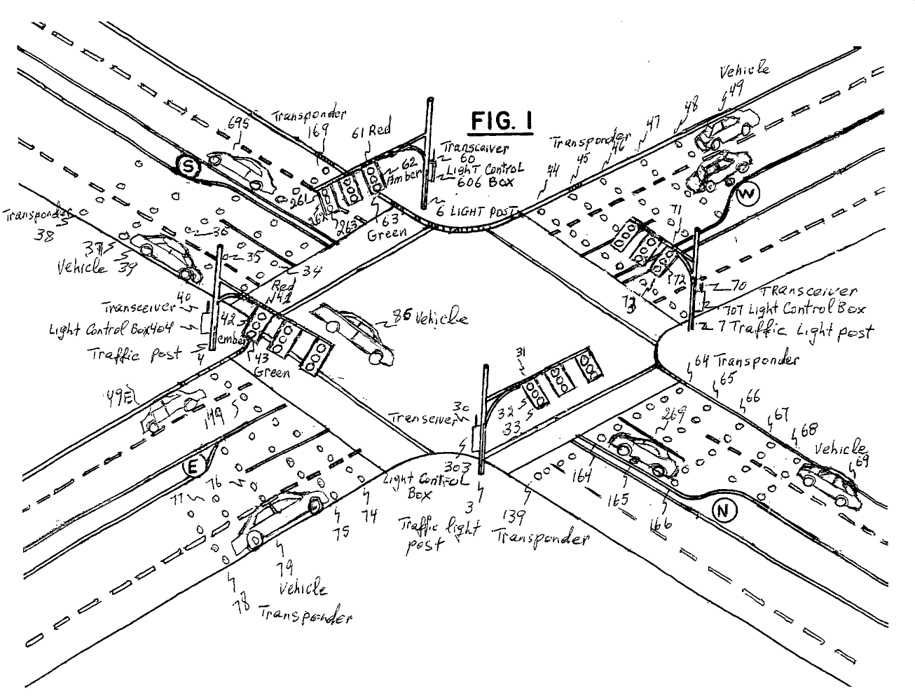

The preferred embodiment of the electronic intersection vehicle collision avoidance system of the present invention is illustrated in as deployed in the exemplary situation of an intersection in FIG. 1. Four traffic light posts, north 3, south 6, west 7, and east 4 are installed on an intersection, each one of said post 3, 6, 7, and 4 are equipped with a traffic light control box 303, 606, 707 and 404, and each one of said traffic control box is connected to corresponding RF transmitters/transceivers 30, 60, 70, and 40 using single or multi frequency band. And each one of said traffic control box simultaneously is connected to corresponding traffic signal lights 31,32, 33, 61, 62, 63, 71, 72, 73, 41,42 and 43. The traffic control box is designed to control and synchronize said RF transmitter transmitting time with said traffic light change time.

Each one of said intersection traffic lanes travel pattern towards an intersection light is equipped with row of plurality of transponders, south side 34, 35, 36, 37, 38, west side 44, 45, 46, 47, 48, north side 64, 65, 66, 67, 68, east side 74, 75, 76, 77, and 78 installed within said traffic lane at a set distance apart. And plurality of vehicle traveling through said traffic lane are equipped with vehicle mount speed comparator CPU having a RF receiver or a transceiver unit using multi frequency band and a transponder reader alone with warning signal generator.

A plurality of vehicles traveling or located at an intersection 39,49,69,79,86, 269 are equipped with vehicle speed comparator CPU, which is equipped with an RF transceiver, to communicate with vehicle(s) travel direction corresponding intersection traffic control box transceivers 30, 40, 60,70. A transponder reader to read street mount transponders example 44, 45, 47, 48, etc. and driver authentication RFID card, to allow operator to start the vehicle and log driver ID information, with the addition of a vehicle immobilizer circuitry. And audio-visual warning alarm circuitry.

When north bound and south bound traffic light control box 303, 606 turns said traffic lights green 33, 63, said traffic light's transmitters will not transmit RF signals. Vehicle 69, traveling southbound, and vehicle 86, 39 traveling north bound traffic direction. The vehicles 69, 86, and 39 equipped with speed compare-tore CPU approaching the intersection, the vehicle's 39, 86, and 69 on board speed compare-tore receiver will not receive RF signals from the said post transceivers 30, 60 the vehicles onboard CPU will not initiate warring signals to the operator's of the vehicles 69, 86, and 39. The vehicles 69,86, and 39 safely cross the intersection.

The traffic control box on west and east side 707, 303 of the intersection changes the traffic lights from green 73, 43 into ember 72, 42 and red 71, 41. The traffic control box transceiver 707, 303 simultaneously sends an RF signals containing unique codes to each one of said particular traffic direction lights. The vehicle(s) 49 traveling east bound and 79 traveling west bound, on board speed compare-tore RF receiver, receives said transmitted RF signal from said traffic light transmitter 40, 70, and upon receipt of said RF signal the vehicle(s) 49, 79 speed comparator CPU reads the particular traffic lane mount transponder(s) 44,45,46,47, and 74, 75,76,77,78 which said vehicle(s) is traveling on. If the speed compare-tore received RF signal code match the particular traffic lane street mount transponder read code. The vehicle(s) 49, 79 speed comparator CPU being connected to said vehicle(s) 49, 79 speedometer or to an accelerometer, begins monitoring and comparing said vehicle speed through the vehicle(s) speedometer or accelerometer. Or said vehicle(s) 49, 79 speed compare-tore CPU compares the travel lap time between said traffic lane asphalt mount transponders 44, 45, 46, 47, and 74, 75, 76, 77, 78 to determine vehicle speed. If the Speed comparator CPU detects vehicle speed is slowing down to stop, or the vehicle is not in motion, the speed comparator-tore CPU will not initiate driver-warning signals. If the speed comparator CPU detects no slow down in vehicle(s) 49, 79 speed, or detects an increase in speed in the particular vehicle(s) 49, or 79 the vehicle speed compare-tore CPU will initiate audiovisual or vibrating warning signal to the driver of a vehicle(s) 49,79 to warn the driver to the presence of amber 42, 72 and or red light 41,71 for the driver to slows down to stop the vehicle(s) 49,79. If driver ignores said warning signals within a preset time does not slow down the vehicle(s) 49 or 79, the vehicle Speed comparator CPU will honk the vehicle(s) 49, or 79 horn, and flash the lights of said vehicle(s) 49 or 79 to warn to the crossing pedestrians 85 and other vehicles 39, 69 to the presence of a possible collision. And in addition, said vehicle(s) 49, 79 speed compare-tore CPU transmits an RF warning signal, which is received by other vehicles 39, 69 speed-comparator CPU located at the particular intersection, said vehicles 39, 69 speed compare-tore CPU will initiate warning alarm signals to the drivers of said vehicle(s) 39,69 the possibility of side, frontal or rear end collision with a vehicle 49 or 79 in which driver has not taken the action to slow down the vehicle in operation at that particular intersection.

The present art teaching, uses a vehicle speed comparator CPU, which when it detects a particular traffic direction red lights RF signal code, and reads particular traffic direction transponder code(s), the comparator's processor clock constantly monitors the vehicle speed. In order the speed comparator processor to reset it's speed comparator clock, which is accomplished when a particular traffic travel direction vehicle mount speed comparator CPU, stops receiving RF signals from a particular travel direction traffic signal light transmitter, Or the vehicle speed comparator clock resets when the vehicle is traveling towards a particular traffic direction comes to full stop, and moves to make a right turn. This will allow driver to make a right turn without vehicle compare-tore CPU transmit a violation alarm signal.

In preferred embodiment of the invention wherein vehicle mount speed compare-tore CPU will release vehicle engine interlock system, only after vehicle mount speed comparator CPU reads the driver Identification card and keeps in its database last known driver ID, such example; as an RFID driver card (driver license), or biometric reader ext. In this teaching of the art, when a particular vehicle 49 driver chooses not to stop at said signal light 41, or after making full stop, crosses the intersection wile the particular vehicle 49 travel direction traffic light is still red 41, and the particular signal light transmitters 40 still transmitting RF coded signals. Once the vehicle 49E cross's and rich the other side of intersection, the vehicle speed comparator reads the transponder(s) 149 on the crossing (east) side of the intersection, and said vehicle 49E mount speed compare-tore CPU upon reading said uniquely coded transponder(s) 149, the vehicle 49E speed compare-tore CPU transmits an RF signal containing information to said vehicle 49 and it's driver with a intersection crossing violation code, which is received by said signal light mount transceiver 40 unit, said captured violation information data is transmitted through wired or wireless signal and processed in a monitoring station PC which is connected to an intranet or internet system. Which is used for electronic ticketing or for displaying the vehicle and it's driver information into patrol vehicle mount PC or portable PDA.

The present art additionally teaches, particular traffic direction lane being equipped with ground mount uniquely coded transponders 164, 165, 166. When a vehicle 269 operator decides to make a left turn at an intersection where traffic light is equipped with left turn signal 6. When left turn lights turn from red 261 to amber 262 then 263 green, only vehicle 269 located within left turn lane safely passes the intersection and makes a left turn on the intersection.

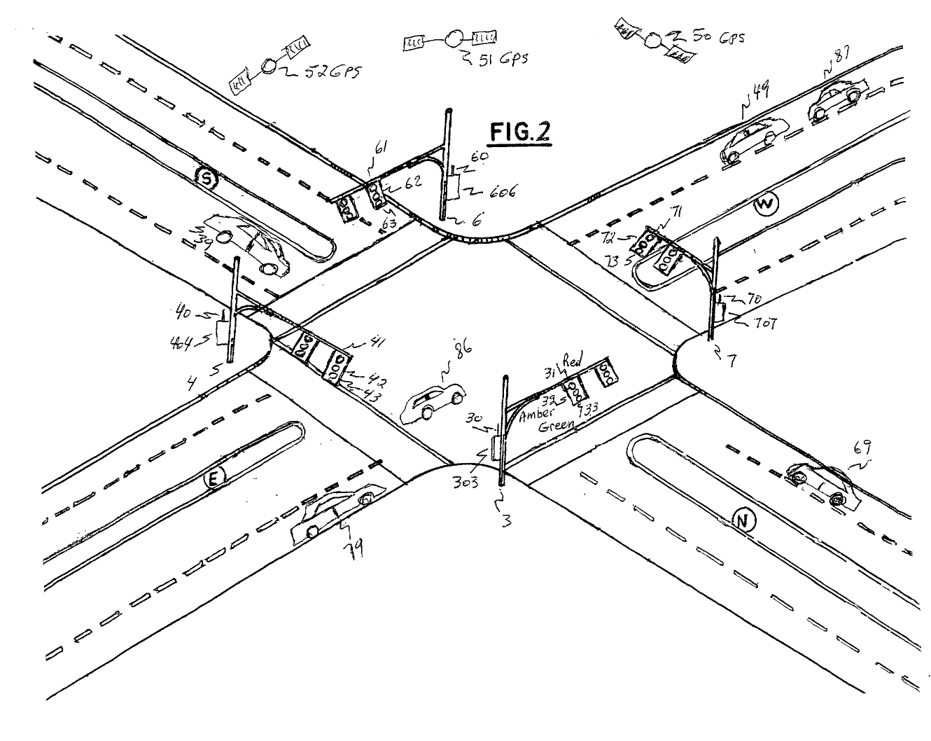

The present art could be implemented in a less expensive and simple way, the art is useful primarily in intersections FIG. 2 where there are no left hand turn signals. This teaching of the simplified art makes the use of street lane transponders not to be used at all, the vehicle(s) 39, 49, 69,79,87,86, speed compare-tore CPU instead is equipped with an electronic compass. In the teaching of this art, when vehicle(s) 49,79, 86,87 mount speed compare-tore CPU receive a particular vehicle traveled direction intersection amber 42,72, and Red light 41, 71 coded RF signal, the vehicle(s) 49,79,86,87 speed comparator CPU compares said received uniquely coded traffic signal 42,72,41,71 with the vehicle(s) 49,79,86,87 mount electronic compass direction position signal, if the intersection light control box 404,707 RF transmitted signal 40,70 code match the with the vehicle mount electronic compass vehicle(s) 49,79,86,87 travel direction position code, then the vehicle(s) 49,79,86,87 speed compare-tore processor starts up the processor speed compare-tore clock to determine vehicle(s) 49,79,86,87 speed, to determine vehicle(s) 49,79,86,87 driver(s) are slowing down to stop the vehicle(s) 49,79,86,87 in compliances with the intersection signal lights. Wile vehicles 39, 69 receiving RF signal from said intersection signal RF transmitters 40, 70 due to the fact the transmitted traffic signal direction code is not matching the vehicle(s) 39,69 direction traveled electronic compass code, thus said vehicles 39,69 comparator CPU will not initiating any warning alarm to the driver(s) of said vehicle(s) where drivers are not slowing down the vehicle(s) 39,69 to stop since said direction traffic signal light 33.63 are Green, and the vehicles 39,69 are safely crossing the intersection.

In a second addition of aspect of the present invention, FIG. 2 said vehicles 39,49,69,79, 86 are equipped with GPS or DGPS receivers, which is connected to said vehicle(s)39,49,69,79,86 mount speed compare-tore CPU. When vehicles 49,79 equipped with GPS based speed comparator CPU, The CPU receives uniquely coded RF signal from said vehicle(s) 49,79 traveled direction intersection traffic control Box 40,70 (red light). Said vehicle(s) 49, 79 speed comparator CPU compares said particular intersection traffic light transmitters 40, 70 uniquely coded received signal, with said of received GPS satellite 50,51,52 received signal. If signal light control box transmitted 40,70 RF coded signal and said vehicle 49,79 GPS receiver received travel direction signal code is a match, the vehicle(s) 49,79 speed compare-tore processor compares the vehicle(s) 49,79 travel direction speed base on received GPS satellite 50,51, 52 signals.

If vehicle 49,79 driver is not in compliances to slow down to stop at the intersection traffic signal, then Vehicle compare-tore CPU will initiate audio-visual or vibrating alarm to the driver of the vehicle and transmit alarm condition signals to warn other vehicles or pedestrians located near said particular intersection.

While the north and south ban traffic signals transmitters 30, 60 are not transmitting RF coded signals; the vehicles 39,69 can pass the intersection without slowing down or stop.

In a preferred embodiment of the present invention said vehicle(s) 49,79 speed compare-tore CPU additionally is equipped with a wireless modem, (UHF, Cellular, and Satellite). If said vehicle(s) 49,79 driver passes an intersection when said traffic lights 41,71 are red, said vehicle wireless modem or satellite unit transmits said vehicle(s) 49,79 and driver information along with vehicle(s) 49,79 GPS position to a central monitoring station, which is connected to an intranet or internet, to make said violating vehicle(s) 49,79 and driver information along with said vehicle(s) 49,79 position available to patrol vehicles, to facilitate officers to intercept said vehicle in violation.

In addition, the speed compare-tore CPU used in the present art could be automatically calibrated to measure vehicle speed on certain streets, roads, and highways by use of street mount or post mount transponders. When a vehicle speed comparator CPU travels near or over a particular street transponder containing information to a set traffic speed, said read certain speed post or street mount transponder(s) will set a maximum speed threshold in to the vehicle speed compare-tore CPU. If vehicle driver driving along said Particular Street, road or highway, exceeds said set speed threshold. The vehicle speed comparator unit will generate an alarm signal to warn the driver of speeding, if driver does not comply, the vehicle speed compare-tore CPU transmits a signal containing information to the particular vehicle and it's driver along with speed violation information, to street or highway mount which relays the information to a receiving monitoring station computer.

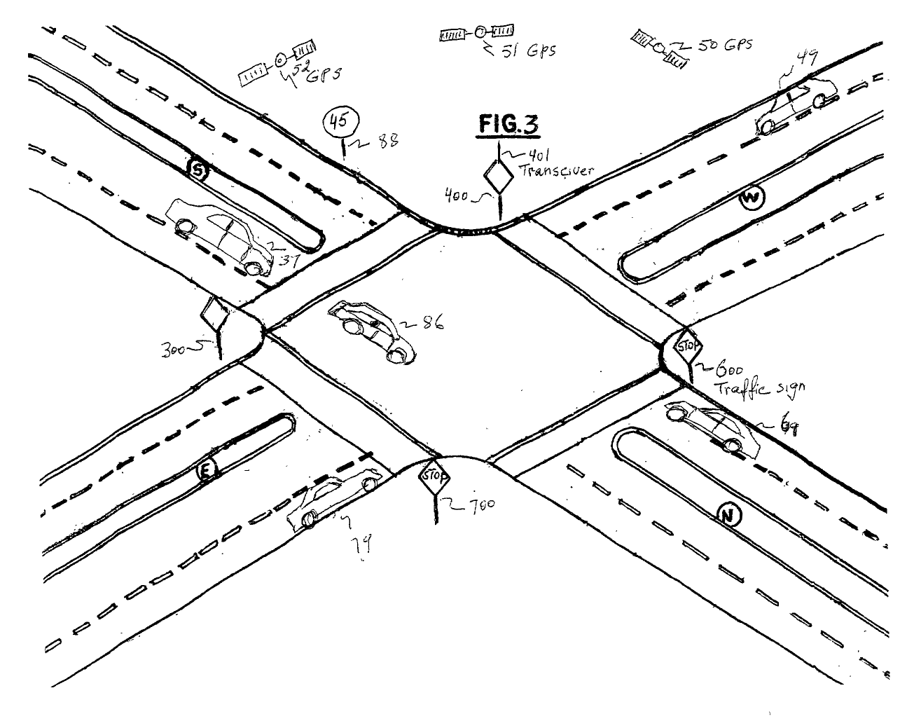

A second embodiment of the present invention, wherein FIG. 3 said street or highway posted speed sign 88 information and stop sing 300, 400,600,700 locations could be downloaded in the vehicle GPS mapping database, and when a vehicle(s)37,49,69,79 arrives at a particular intersection and driver does not slow down at a set distance to make a full stop, or the vehicle operator at certain street or highway travels faster then posted signs 88, the vehicle(s) 37,49,69,79 GPS based speed compare-tore compares the vehicle 37,49,69,79 speed travel speed on the street or at the intersection based on received GPS signals 50,51, 52, if vehicle(s) 37,49,69,79 is slowing down to stop, the comparator will not issue warning alarm signals. If vehicle(s) 37,49,69,79 is not in compliance to slow down to stop, or vehicle traveling over the speed limit zone. The vehicle(s) 37,49,69,79 GPS based modem or satellite unit transmits a vehicle(s) 37,49,69,79, violation code along with driver and vehicle information and vehicle location to a monitoring station. In addition the present inventions vehicle comparator CPU after reading particular street or highway speed limit signal 88 transmitted signal(s) or using the vehicle GPS map data base found information to a particular location speed information, the vehicle speed comparator CPU controls the vehicle speed electronically for the driver not to be able to drive the vehicle over said particular location speed limit.

And the speed comparator CPU used in the present invention is capable to activate a particular vehicle brake to slow down a vehicle when said vehicle compare-tore CPU does not detect vehicle speed slowing down after a predetermine time said vehicle speed compare-tore receipt of an slow down RF signal from a particular direction intersection signal light control box transmitter.

In other aspect of invention, the vehicle mount speed comparator not necessarily to receive red signal light RF signal from particular intersection signal light control transmitter unit. The vehicle speed control CPU used in the present invention is capable of receiving unique coded red light stop signal(s) directly from a satellite unit.

And finally the Transmitters found in intersection traffic lights could be utilized in traffic stop singe FIG. 3, without having traffic lights, in this aspect when a vehicle arrives at intersection being equipped with stop singe(s) 300,400,600,700, one of stop signs 400 contains an RF transmitter or transceiver 401. Said intersection stop sign mount transmitter(s) transmits a unique coded signal, and when a vehicle(s) 37,49,69,79 equipped with a vehicle speed compare-tore CPU approaches said intersection at a set distance, the vehicle(s) 37,49,69,79 speed compare-tore CPU upon receipt of said uniquely code signal from said stop sign transceiver 401 compares vehicle speed. If a vehicle(s) 37,49,69,79 come to full stop then the Speed compare-tore processor will reset said comparator clock so the vehicle can pass, said vehicle(s) 37,49,69,79 speed compare-tore CPU without transmitting warning alarm signals.

What is claimed:

1- A method for avoiding intersection vehicle collision, said system comprising of;
Intersection traffic signal(s) condition transmitter(s) and or a transceiver(s).
A Vehicle mount speed compare-tore CPU, with a receiver and or a transceiver.
A Vehicle travel direction detection database processor circuitry.
And a vehicle warning alarm circuitry.
Said intersection traffic signal transmitter(s) and or transceivers(s) at a pre-set time transmitting unique coded signal containing information to each One of said particular traffic direction signal condition. A plurality of vehicle traveling towards said intersection, equipped with vehicle speed compare-tore CPU, said vehicle speed comparator CPU receiving said uniquely coded traffic Signal condition signal(s).
When a particular direction travel vehicle(s) comparator CPU,
Received particular direction intersection traffic signal condition code (ember, Red signal light, or stop sign or speed limit sign) match with said vehicle travel direction detection processor read code. At a predetermine vehicle distance from said intersection, said vehicle speed comparator processor clock compares said vehicle speed said vehicle speed compare-tore CPU determines said vehicle speed being in compliance based on said vehicles location distance from said traffic signal(s). If said vehicle speed compare-tore processor reading indicates said vehicle speed is not in compliances with said traffic signal condition, said vehicle speed compare-tore CPU will initiate warning alarm signal(s)

2- A method defined in claim 1 wherein each one of said intersection is equipped with Plurality of street mount transponders installed within a set distance apart from each other, on each side of said intersection traffic direction for the identification of a particular traffic direction and or for the purpose of setting speed zone(s)

3- A method defined in claim 1 and 2 wherein when each one of said vehicle speed compare tore CPU additionally is equipped with transponder reader. Said vehicle speed compare-tore CPU receiving said traffic signal condition signal(s) and said vehicle speed comparator CPU reading said intersection street mount transponders for the activation of said vehicle speed compare-tore processor clock to monitoring said vehicle speed.

4- A method defined in claim 3 wherein said vehicle speed comparator CPU is comparing said vehicle speed based on said vehicle speedometer, or accelerometer, or by said vehicle speed comparator transponder reader transponders read laps time.

5- A method defined in claim 1 wherein said vehicle speed comparator CPU is using a electronic compass to determine said vehicle travel direction.

6- A method defined in claim 1 wherein said vehicle speed compare-tore CPU generating vehicle mount audio and or visual or vibrating alarm signal(s) to warn said vehicle driver to slow down said vehicle speed and or to stop said vehicle at said intersection.

7- A method defined in claim 1 wherein said vehicle speed comparator CPU upon detecting vehicle speed is not in compliance with said traffic condition signal(s) at a predetermine time, said vehicle speed comparator CPU, generating audio and or visual alarm signal(s) to warn pedestrians and or vehicles located within said intersection.

8- A method defined in claim 1 wherein said vehicle speed comparator CPU in addition is equipped Electronic driver authentication circuitry.

9- A method defined in claim 8 wherein said vehicle will operate upon said electronic Driver authentication circuitry reading said driver authentication.

10- A method defined in claim 8 wherein said electronic driver authentication circuitry is an biometric reader or a driver RFID reader or a driver magnetic card reader, or a key-fob, or voice recognition reader.

11- A method defined in claim 1 wherein each one of said vehicle speed comparator CPU transmitter has a unique code for identifying said vehicle.

12- A method defined in claim 1 wherein each one of said vehicle(s) peed is not in compliance with said particular intersection traffic signal condition signal(s). At a preset time said vehicle speed comparator CPU will transmit an RF signal to warn other vehicle drivers(s) located at said intersection, said other vehicle speed comparator CPU upon receipt of said signal, will initiate an audio and or visual or vibrating alarm signal to the driver indicating the presence of possible traffic intersection collision.

13- A method defined in claim 1 wherein said vehicle crosses said intersection or the vehicle does not make a full stop in the presence of a traffic signal condition(s) said vehicle speed comparator CPU transmits an RF signal(s), said transmitted RF signal contains information to said vehicle ID and or contains information to said vehicle driver. Said intersection transceiver unit upon receipt of said signal(s), transmits said vehicle and or driver, with information relating to said particular intersection location, to a monitoring station computer for reviewing, and or for processing electronic traffic violation ticketing system.

14- A method defined in claim 1 wherein said vehicle speed comparator CPU in addition is equipped with a vehicle GPS receiver unit. For providing vehicle travel direction, speed, distance, and location information to said vehicle speed comparator CPU.

15- A method defined in claim 1 wherein said vehicle speed comparator CPU, in addition is equipped with a vehicle GPS unit connected to a UHF/VHF, Satellite, or cellular modem. When a vehicle crosses a particular intersection or passes said intersection without making a full stop, or when said vehicle traveling above particular location speed limit, where there is the presence of traffic signal condition, Said vehicle GPS unit transmits said vehicle traffic violation condition with signal(s) containing information to said vehicle, and or driver and it's location through said vehicle GPS unit UHF/VHF, Satellite, or cellular modem, to a monitoring station computer.

16- A method defined in claim 15 wherein said monitoring station computer is Connected to intranet, and or Internet for providing said information to fix or mobile computers or PDA, for tracking said vehicles.

17- A method for avoiding intersection vehicle collision system, wherein plurality of vehicles equipped with GPS receiver connected to a vehicle speed comparator CPU. And to a warning alarm generating circuitry. Said GPS unit database containing location information of plurality of intersection traffic signals and or traffic location speed limit information of a wide area. Wherein said particular vehicle(s) traveling towards an interaction, said intersection location information is within said vehicle GPS unit mapping. At preset vehicle distance location detection from said intersection, said vehicle GPS unit transmits signal(s) to said vehicle speed comparator CPU containing information to said vehicle speed, location, and vehicle travel direction code. If vehicle speed is in compliance with given vehicle location, the vehicle speed comparator will not produce alarm signal(s) if vehicle is not in compliance said vehicle speed compare-tore CPU will initiate warning collision alarm signal(s)

18- A method defined in claim 17 wherein said collision alarm signal are audio and or visual or vibrating signal to alert the driver. And or are audio and or visual signals which is produced by said vehicle speed comparator CPU at a predetermine time to warn the pedestrians or other vehicles located at the particular intersection. And or transmitting an RF signal to other vehicles equipped with speed comparator CPU Located at the particular intersection, to warn the other vehicle driver(s)

19- A method defined in claim 17 wherein said vehicle Speed compare-tore CPU, in addition is equipped with electronic driver authentication circuitry, and a UHF/VHF, Satellite, or cellular modem. When a vehicle crosses an intersection or passes without full stop a particular intersection where there is traffic signal conditions, wherein said information is located within said vehicle GPS mapping database, or if said vehicle traveling speed is higher then said traffic signal conditions, said vehicle speed comparator transmits said vehicle traffic violation conditions to a monitoring station with information containing to the particular vehicle ID and or to it's driver ID.

20- A method defined in claim 1 and 17 wherein said vehicle speed comparator CPU is controlling said vehicle speed in accordance to said street or highway read speed limit signal condition, or according to said vehicle GPS unit map data base information.

21- A method defined in claim 1 and 17 wherein said vehicle speed compare-tore is equipped with an electronic and or electromechanically brake control circuitry, said circuitry is Controlling said vehicle brakes. Said vehicle alarm condition signal is activating said vehicle electronic brake control circuitry.

22- A method defined in claim 1 and 17 wherein said traffic signal condition transmitted signals are generated from a satellite(s)
